(19) United States
(12) Patent Application Publication
(10) Pub. No.: US 2025/0240710 A1
(43) Pub. Date: Jul. 24, 2025

(54) METHOD AND APPARATUS FOR PROVIDING NETWORK SLICE INFORMATION IN WIRELESS COMMUNICATION SYSTEM

(71) Applicant: Samsung Electronics Co., Ltd., Suwon-si, Gyeonggi-do (KR)

(72) Inventors: Hoyeon LEE, Suwon-si (KR); Jungshin PARK, Suwon-si (KR)

(21) Appl. No.: 18/700,905

(22) PCT Filed: Oct. 27, 2022
(86) PCT No.: PCT/KR2022/016564

§ 371 Date: Apr. 12, 2024

(30) Foreign Application Priority Data
Oct. 27, 2021 (KR) 10-2021-0144252

(51) Int. Cl. H04W 48/18; H04W 36/14; H04W 48/08; H04W 60/04

(52) U.S. Cl. CPC H04W 48/18; H04W 36/144; H04W 48/08; H04W 60/04

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services.

### TECHNICAL FIELD

The disclosure relates to a wireless communication system, and it relates to a method and apparatus for providing network slice information in a wireless communication system.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

### DISCLOSURE OF INVENTION

### Technical Problem

In order to use a session in a network slicing, S-NSSAI information associated with the session is required. In case where a terminal does not know the S-NSSAI information associated with the session, problems may occur in using the session.

### Solution to Problem

In the disclosure for solving the above problems, a method performed by an access and mobility management function (AMF) in a wireless communication system comprises receiving, from a base station, a first message including protocol data unit (PDU) session identifiers; transmitting, to a network entity, a second message; receiving, from the network entity, a third message including single-network slice selection assistance information (S-NSSAI) associated with the PDU session identifier; determining an allowed slice based on the S-NSSAI; and transmitting, to the base station, a fourth message including the allowed slice.

In some examples, the network entity is a previously selected AMF or mobility management entity (MME), the second message is a terminal information request message, and the third message is a terminal information response message.

In some examples, the previously selected AMF or MME is identified based on information associated with the terminal ID included in the first message.

In some examples, the network entity is a session management function (SMF), the second message is a PDU session context request message, and the third message is a PDU session context response message.

In some examples, a fifth message including at least one of a request slice and a terminal ID is transmitted from the terminal to the base station, and the fourth message is transmitted from the base station to the terminal.

In another example of the disclosure, a method performed by a base station in a wireless communication system, comprises receiving, from a terminal, a first message including at least one of a request slice and a terminal ID; selecting an access and mobility management function (AMF) based on at least one of the request slice and the terminal ID; transmitting, to the AMF, a second message including protocol data unit (PDU) session identifiers; receiving, from the AMF, a third message including an allowed slice; and transmitting, to the terminal, the third message, wherein the allowed slice is determined based on single-network slice selection assistance information (S-NSSAI) associated with the PDU session identifier.

In some examples, a fourth message including the S-NSSAI is transmitted from a network entity to the AMF.

In some examples, the network entity is one of a previously selected AMF, a mobility management entity (MME), and a session management function (SMF).

In another example of the disclosure, an access and mobility management function (AMF) comprises a transceiver capable of transmitting and receiving at least one signal; and a controller coupled with the transceiver, wherein the controller is constituted to receive, from a base station, a first message including protocol data unit (PDU) session identifiers, transmit, to a network entity, a second message, receive, from the network entity, a third message including single-network slice selection assistance information (S-NSSAI) associated with the PDU session identifier, determine an allowed slice based on the S-NSSAI, and transmit, to the base station, a fourth message including the allowed slice.

In still another example of the disclosure, a base station comprises a transceiver capable of transmitting and receiving at least one signal; and a controller coupled with the transceiver, wherein the controller is constituted to receive, from a terminal, a first message including at least one of a request slice and a terminal ID; select an access and mobility management function (AMF) based on at least one of the request slice and the terminal ID; transmit, to the AMF, a second message including protocol data unit (PDU) session identifiers; receive, from the AMF, a third message including an allowed slice; and transmit, to the terminal, the third message, wherein the allowed slice is determined based on single-network slice selection assistance information (S-NSSAI) associated with the PDU session identifier.

### Advantageous Effects of Invention

According to an embodiment of the disclosure, the S-NSSAI information associated with the session may be provided to the terminal.

### BRIEF DESCRIPTION OF DRAWINGS

FIG. 1 illustrates a system structure of a 5GS according to an embodiment of the disclosure.

FIG. 2 illustrates a session establishment procedure according to an embodiment of the disclosure.

FIG. 3 illustrates a terminal registration procedure according to an embodiment of the disclosure.

FIG. 4 illustrates a handover procedure according to an embodiment of the disclosure.

FIG. 5 is a diagram illustrating a structure of a terminal according to an embodiment of the disclosure.

FIG. 6 is a diagram illustrating a structure of a network entity according to an embodiment of the disclosure.

### MODE FOR THE INVENTION

Hereinafter, embodiments of the disclosure will be described in detail with reference to the accompanying drawings. Further, details of known functions or constitutions incorporated herein are omitted when it is determined that the description of such details may make the subject matter of the disclosure unnecessarily unclear. Further, the following terms are defined in consideration of the functionality in the disclosure, and they may vary according to the intention of a user or operator, customs, etc. Therefore, the definition should be made on the basis of the overall content of the present specification.

Various advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. The same or like reference numerals designate the same or like elements throughout the present specification.

Hereinafter, the disclosure relates to a method and an apparatus for supporting various services in a wireless communication system. Specifically, the disclosure describes a technique for supporting various services by managing terminal registration to use a network slice in a wireless communication system.

In the following description, terms for identifying access nodes, terms referring to network entities or network functions (NFs), terms referring to messages, terms referring to interfaces between network entities, terms referring to various identification information, etc., are illustratively used for the sake of convenience. Therefore, the disclosure is not limited by the terms as used below, and other terms referring to subjects having equivalent technical meanings may be used.

For convenience of description, the disclosure uses terms and names defined in a 3rd-generation partnership project long-term evolution (3GPP LTE) and 5G standards. However, the disclosure is not limited by the terms and names, and may be equally applied to a system that is based on another standard.

Hereinafter, for convenience of description, the name of NF (e.g., AMF, SMF, NSSF, or the like) is used as a target for exchanging information for access control and state management. However, embodiments of the disclosure can be applied equally even in a case that NF is actually implemented as an instance (which is AMF instance, SMF instance, NSSF instance, or the like, respectively).

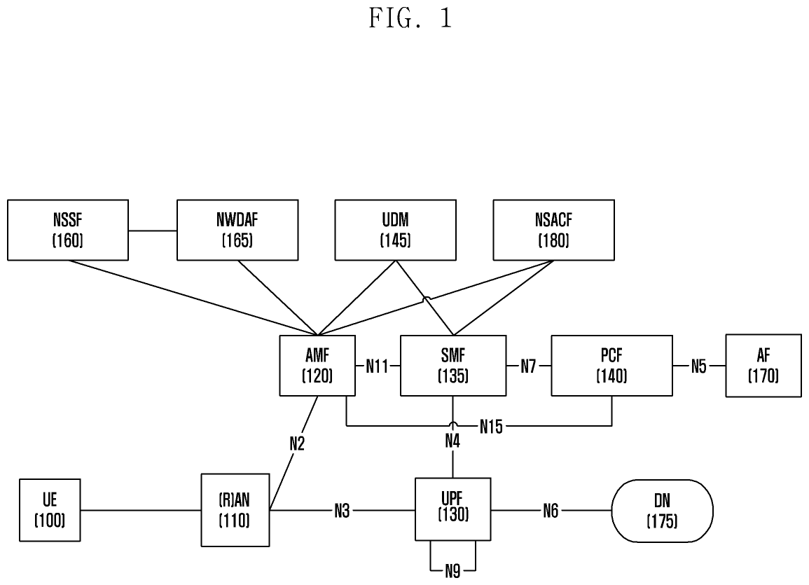

FIG. 1 illustrates a system structure of a 5GS according to an embodiment of the disclosure. The 5GS may include a 5G core network, a base station, a terminal, and the like. The 5G core network (or 5G core network) may include an AMF 120, a SMF 135, a UPF 130, a PCF 140, a UDM 145, a NSSF 160, a NWDAF 165, N3F or the like.

A terminal 100 may access the 5G core network through a radio access network base station 110. The radio access network base station 110 may support a 3GPP access network type (e.g., NR, E-UTRA, etc.) or a non-3GPP access network type (e.g., Wi-Fi, etc.). The terminal 100 may be connected to the AMF 120 and N2 interface through the base station 110, and may be connected to the UPF 130 and an N3interface. The base station 110 may be referred to as an ‘access point (AP)’, an ‘eNodeB (eNB)’, a ‘5th generation (5G) node’, a ‘gNodeB (gNB)’, or other terms having equivalent technical meanings to those of the above-described terms, in addition to the base station. A non-3GPP function (N3F) is a network function (NF) operating as an N2 interface and N3 interface terminations for the terminal 100 accessed through a non-3GPP access network (e.g., WiFi, etc.) not defined in 3GPP. The N3F may process an N2 control plane signaling and an N3 user plane packet.

The access and mobility management function (AMF) 120 is a network function (NF) that manages wireless network access and mobility for a terminal (UE). The session management function (SMF) 135 is an NF that manages a session for a UE, and the session information includes quality of service (QOS) information, billing information, and packet processing information. The user plane function (UPF) 130 is an NF that processes user plane traffic and is controlled by the SMF 135. The policy control function (PCF) 140 is an NF that manages operator policy for providing services in a wireless communication system. The user data management (UDM) 145 is an NF that stores and manages UE subscription information. The unified data repository (UDR) is an NF that stores and manages data. The UDR may store UE subscription information and provide the UE subscription information to the UDM. In addition, the UDR may store operator policy information and provide operator policy information to the PCF. The network data analytics function (NWDAF) 165 is an NF that provides analysis information for the operation of 5G systems. The NWDAF may collect data from other NFs or operations, administration and maintenance (OAM) constituting the 5G system, analyze the collected data, and provide analysis results to other NFs. The network slice admission control function (NSACF) 180 is an NF that monitors and controls the number of registered UEs and the number of sessions of a network slice that is a target of a network slice admission control (NSAC). The NSACF stores configuration information on the maximum number of registered UEs and maximum number of sessions for each network slice.

Hereinafter, entities that exchange information for access control and state management will now be collectively called NF for convenience of explanation. However, embodiments of the disclosure may be equally applied to a case that the NF is actually implemented as an instance (which is AMF instance, SMF instance, NSSF instance, or the like, respectively).

In the disclosure, an instance may mean a state in which a particular NF exists in the form of software code and can execute physical and/or logical resources allocated from a computing system in order to perform a function of an NF in a physical computing system, for example, a particular computing system existing on a core network. Thus, the AMF instance, SMF instance, and NSSF instance may mean capable of using physical and/or logical resources allocated from a particular computing system existing on the core network for an AMF operation, SMF operation, and NSSF operation, respectively. Consequently, the AMF instance, SMF instance, and NSSF instance, which use physical and/or logical resources allocated from a particular computing system existing on the network for AMF, SMF, and NSSF operations, may perform the same operations as in the case of physical AMF, SMF, and NSSF apparatuses. Thus, in embodiments of the disclosure, an item described as an NF (an AMF, an SMF, a UPF, an NSSF, an NRF, a SCP, etc.) may be replaced with an NF instance, or conversely, an item described as an NF instance may be replaced with an NF and applied. Likewise, in embodiments of the disclosure, an item described as a network slice may be replaced with a network slice instance, or conversely, an item described as a network slice instance may be replaced and applied with a network slice.

According to one embodiment of the disclosure, in the 5G system defined by the 3GPP, one network slice may be referred to as single-network slice selection assistance information (S-NSSAI). The S-NSSAI may include a slice/service type (SST) value and a slice differentiator (SD) value. The SST may indicate a characteristic of a service supported by the slice (for example, eMBB, IoT, URLLC, V2X, etc.). The SD may be used as an additional identifier for a specific service referred to as the SST.

The NSSAI may be constituted of one or more S-NSSAIs. For example, the NSSAI may include, but are not limited to, a configured NSSAI stored in the UE, a requested NSSAI requested by the UE, an allowed NSSAI allowed to be used by the UE determined by the NF (e.g., AMF, NSSF, etc.) of a 5G core network, subscribed NSSAI where the UE subscribes, etc.

The UE 100 may be simultaneously connected to the access network 110 and registered in the 5G system. Specifically, the UE 100 may access the base station 110 and perform the AMF 120 and a UE registration procedure. During the registration procedure, the AMF 120 may determine an allowed slice (Allowed NSSAI) available to the UE accessing the base station 110 and allocate the determined allowed slice to the UE 100.

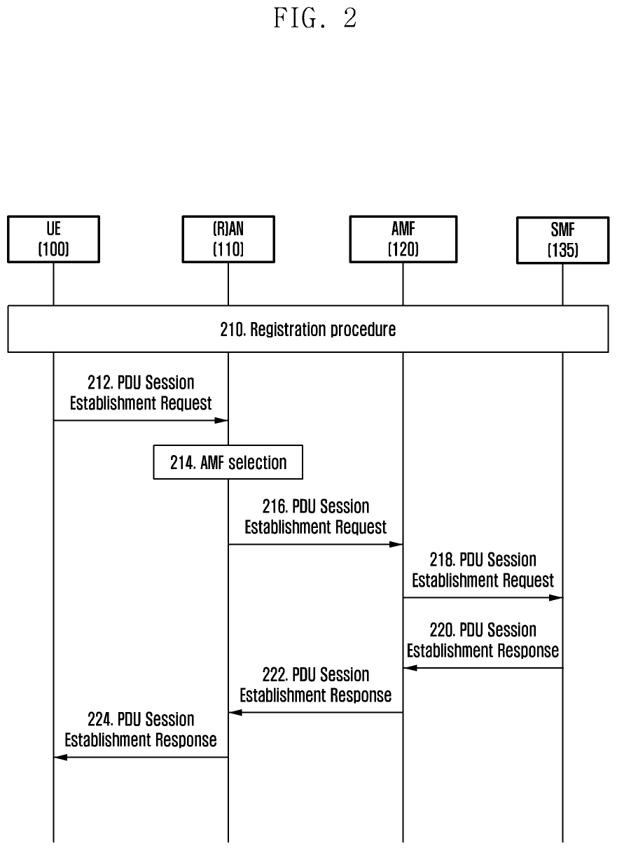

FIG. 2 illustrates a session establishment procedure according to an embodiment of the disclosure. With reference to FIG. 2, the UE 100 according to an embodiment of the disclosure may access the base station 110 and perform a session establishment procedure with the AMF 120.

Operation 210: The UE 100 may perform a UE registration procedure with the AMF 120. During the registration procedure, the UE 100 may transmit a requested slice (Requested NSSAI) that the UE wants to use to the AMF 120, and the AMF 120 may determine an allowed slice (Allowed NSSAI) based on the UE's requested slice, the UE's current location, and the UE's subscription slice (subscribed S-NSSAIs). The allowed slice may include one or more pieces of S-NSSAI information that the UE 100 is allowed to use by accessing a 5G network. The AMF 120 may store the allowed slice as UE context. The AMF 120 may transmit the allowed slice information to the UE 100. The UE 100 may store the received allowed slice and use the received allowed slice later in a protocol data unit (PDU) session establishment procedure.

Operation 212: The UE 100 may access the base station 110 and transmit a PDU session establishment request message to the base station 110. The PDU session establishment request message may include PDU session ID and UE ID. The PDU session establishment request message may not include the slice information (e.g., S-NSSAI) that the UE wants to use.

Operation 214: According to an embodiment of the disclosure, the base station 110, which has received the PDU session establishment request message, may select the AMF to transmit the PDU establishment request message based on the UE ID (e.g., 5G-GUTI, etc.) received from the UE 100. For example, the base station 110 may select the AMF corresponding to the AMF identifier included in the UE ID.

Operation 216: The base station 110 may transmit an N2 message to the AMF 120 selected in operation 212. The N2 message may include the PDU session establishment request message.

Operation 218: The AMF 120 may process the PDU session establishment request message received from the UE. In case where the slice information (e.g., S-NSSAI) is not included in the PDN session establishment request message, the AMF 120 may determine the S-NSSAI to be used for establishing a PDU session based on the operator policy and the UE's allowed slice information. As the S-NSSAI to be used for establishing a PDU session, one of the S-NSSAI(s) included in the allowed slice may be selected. The AMF 120 may store the S-NSSAI determined by the AMF along with the PDU Session ID included in the PDU session establishment request message. In addition, the AMF 120 may store information (or an indicator) indicating that the corresponding PDU session, referred to as the PDU session ID, is a session established in 5G as the UE context.

The AMF 120 may transmit the PDU session establishment request message to the SMF 135. The PDU session establishment request message may include PDU Session ID and the S-NSSAI information allocated by the AMF.

Operation 220: The SMF 135 may process the received PDU session establishment request message to establish the PDU session. In addition, the SMF 135 may store the S-NSSAI information along with the PDU Session ID.

The SMF 135 may transmit a PDU session establishment response message to the AMF 120.

Operation 222: The AMF 120 may transmit, to the UE 100, a response message (PDU session establishment response message) for the PDU session establishment request message received in operation 214. The PDU session establishment response message may not include the S-NSSAI information selected by the AMF 120.

Operation 224: The base station 110 may transmit the PDU session establishment response message received from the AMF 120 to the UE 100. The UE 100, which has received the PDU session establishment response message, may know that the PDU session requested in operation 210 has been established. However, the UE 100 may not know the S-NSSAI information associated with the established PDU session. The UE 100 according to an embodiment of the disclosure may store information (or indicator) indicating that the corresponding PDU session, referred to as a PDU session ID, is a session established in 5G. In addition, the UE 100 may store 5G QoS parameters associated with the PDU session. The UE may transmit and receive data using the established PDU session.

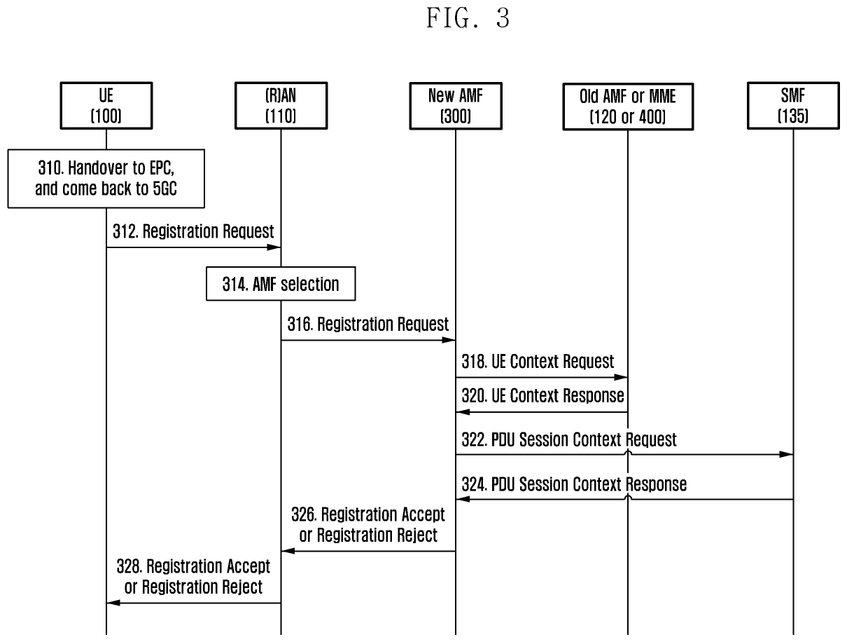

FIG. 3 illustrates a UE registration procedure according to an embodiment. With reference to FIG. 3, the UE 100 according to an embodiment of the disclosure may access the base station 110 to perform a registration procedure with an AMF 300.

Operation 310: The UE, which has established the PDU session in 5G using the procedure in FIG. 2, may move to an evolved packet core (EPC) and continuously use the PDU session established in 5G. In addition, the UE may move back to 5GC and perform the registration procedure illustrated in FIG. 3 to continuously use the PDU session.

Operation 312: The UE 100 may access the base station 110 to transmit a registration request message to the base station 110. The registration request message may include a requested slice (requested NSSAI) to be used by the UE 100.

The UE 100 according to an embodiment of the disclosure may want to continuously use the PDU session established through the procedure illustrated in FIG. 2. In order to continuously use the PDU session, the registration request message must be constituted by including the S-NSSAI associated with the PDU session in the request slice, but the UE may not know the S-NSSAI associated with the PDU session. Accordingly, the UE may include various information in the registration request message. For example, the UE may include a specific S-NSSAI(s) (e.g., default S-NSSAI(s)), or an empty S-NSSAI(s) in the request slice. Alternatively/additionally, the UE may include, in the registration request message, an indicator indicating that the PDU session referred to as PDU session ID(s) is the session established in 5GC.

Operation 314: The base station 110, which has received the registration request message according to an embodiment of the disclosure, may select an AMF to which the registration request is transmitted, based on at least one of the requested NSSAI and UE ID received from the UE 100. For example, the base station 110 may select an AMF which may support the requested NSSAI. In addition, the base station 110 may select an AMF corresponding to the AMF information included as part of the UE ID. The AMF selected by the base station 110 may be the AMF 120 that has established the PDU session of the UE through the procedure illustrated in FIG. 2, or may be another AMF 300.

Operation 316: The base station 110 may transmit an N2 message to the selected AMF 120. The N2 message may include a registration request message. In addition, the N2 message may include N2 parameters.

Operation 318: The AMF 300 may process the registration request message of the UE. For the purpose of explaining an embodiment of the disclosure, it is assumed that the AMF 300, which is different from the AMF 120 that has established the PDU session of the UE through the procedure illustrated in FIG. 2, is selected by the base station 110. In case where the AMF 120 that has established the PDU session of the UE through the procedure illustrated in FIG. 2 is selected by the base station 110, operations 318 to 320 may be omitted.

The AMF 300 may know the AMF (serving AMF) 120 that has previously supported the UE 100 based on the AMF information included as part of the UE ID included in the registration request message. The AMF 300 is referred to as a new AMF and the AMF 120 is referred to as an old AMF. The new AMF 300 may transmit a UE information request message to the old AMF 120.

In addition, the AMF 300 may know the MME 400 that has previously supported the UE 100 based on the MME information included as part of the UE ID included in the registration request message. The AMF 300 may transmit a UE information request message to the MME 400.

Operation 320: The old AMF 120 or MME 400 may transmit the stored UE context information to the new AMF 300. The UE context may include at least one of the allowed slice of the UE 100, the S-NSSAI (determined by the AMF 120) associated with the PDU session ID, and information (or indicator) indicating that the corresponding PDU session, referred to as the PDU session ID, is the session established in 5G.

Operation 322: The AMF 300 may know that the UE 100 is the UE that has moved from the EPC to 5GC. In addition, the AMF 300 may determine the SMF serving the PDN connection (PDU session) that the UE 100 is using in the EPC. The AMF 300 may transmit a PDU session context request message to the SMF 135 serving the PDN connection (PDU session). The PDU session context request message may include a PDU session ID.

Operation 324: The SMF 135 may reply the session information referred to as the PDU session ID to the AMF 300. The PDU session context response message transmitted from the SMF 135 to the AMF 300 may include the S-NSSAI information associated with the session. The AMF 300 may store the S-NSSAI information associated with the PDU session referred to as the PDU session ID received from the SMF 135.

Operation 326: The AMF 300 according to an embodiment of the disclosure may determine an allowed slice to be provided to the UE 100 based on at least one of the information received from the UE 100, the information received from the old AMF 120 (or the UE context information stored by the AMF), and the information received from the SMF 135. In addition, the AMF 300 may determine to continuously provide the PDN connection that the UE 100 is using in the EPC, referred to by the PDU session ID, in 5G.

For example, the AMF 300 may know that the UE 100 does not know the S-NASSAI associated with the PDU session, based on at least one of the information received from the UE 100 and the information received from the old AMF 120 (or the UE context information stored by the AMF). In addition, the AMF 300 may know that the PDU session is the session established in 5GC, based on at least one of the information received from the UE 100 and the information received from the old AMF 120 (or the UE context information stored by the AMF). Accordingly, the AMF 300 may determine to continuously provide the PDU session in 5G. The AMF 300 may know the S-NSSAI associated with the PDU session, based on at least one of the information received from the old AMF 120 (or the UE context information stored by the AMF) and the information received from the SMF 135.

The AMF 300 according to an embodiment of the disclosure may include the S-NSSAI information associated with the PDU session in a registration accept message in order to provide the UE 100 with the S-NSSAI information associated with the PDU session.

For example, the allowed slice included in the registration accept message may include the S-NSSAI associated with the PDU session. The AMF 300 may include the S-NSSAI associated with the PDU session, as an S-NSSAI mapped to correspond to a specific S-NSSAI (for example, default S-NSSAI) or empty S-NSSAI included in the request slice received from the UE. In case where a plurality of PDU sessions is established in 5GC without S-NSSAI, the information corresponding to each PDU session may be included in the allowed slice in the form of S-NSSAI associated with the PDU session, as an S-NSSAI mapped to correspond to a specific S-NSSAI (for example, default S-NSSAI) or empty S-NSSAI. In this case, the AMF 300 may constitute the S-NSSAIs associated with the PDU session, as the S-NSSAIs that are mapped to correspond to the specific S-NSSAIs (for example, default S-NSSAIs) or empty S-NSSAIs of the allowed slice, according to the order of PDU sessions requested by the UE 100. Alternatively, the AMF 300 may include PDU session information (for example, PDU session ID, etc.) corresponding to each mapped S-NSSAI in the registration accept message.

The AMF 300 may include the determined allowed slice in the registration accept message and transmit the same to the UE 100. If there are no slices available to the UE, that is, there are no allowable slices, the AMF 120 may transmit a registration reject message.

Operation 328: The base station 110 may transmit the registration accept or registration reject message received from the AMF 120 to the UE 100. The UE 100, which has received the registration accept message, may identify the S-NSSAI information associated with the PDU session based on the information included in the registration accept message. For example, the UE 100 may know the S-NSSAI information associated with the PDU session, based on the S-NSSAI(s) information associated with the PDU session, as an S-NSSAI(s) mapped to correspond to a specific S-NSSAI(s) (for example, default S-NSSAI(s)) or empty S-NSSAI(s) included in the allowed slice. The UE 100 may store the S-NSSAI information associated with a PDU session.

In the UE according to an embodiment of the disclosure, in case where the 5G QoS parameter associated with a corresponding PDU session, referred to as a PDU session ID, is stored in the UE, in case where information (or indicator) indicating that the corresponding PDU session is a session established in 5G is stored in the UE, or in case of receiving the S-NSSAI information associated with a PDU session, the UE 100 may continuously use the PDU session in 5GC.

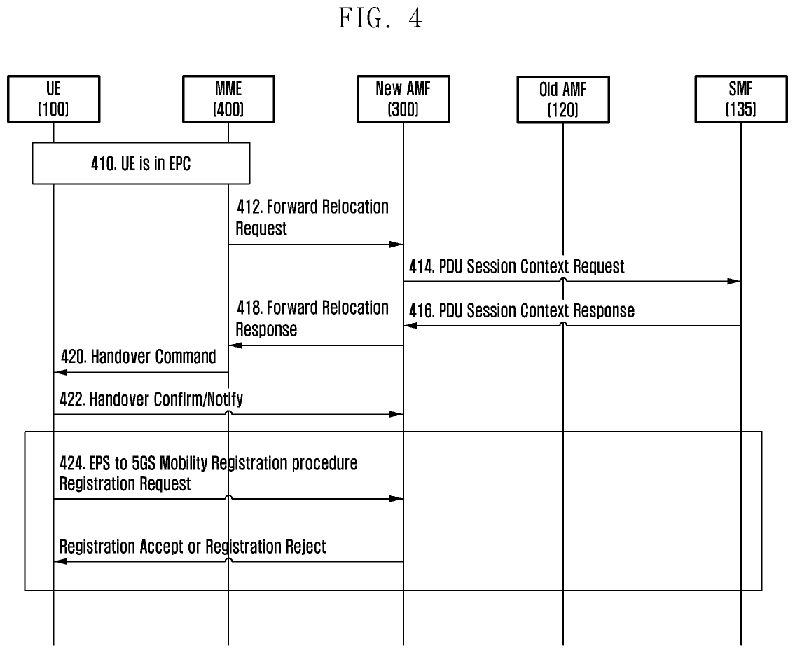

FIG. 4 illustrates a handover procedure according to an embodiment of the disclosure. With reference to FIG. 4, the UE 100 according to an embodiment of the disclosure may access the EPC and use the service and then handover to 5GC.

Operation 410: The UE, which has established a PDU session in 5G using the procedure of FIG. 2, moves to the EPC and may continuously use the PDU session established in 5G.

Operation 412: The MME 400 supporting the UE 100 in EPC may determine to handover the UE to 5G. Accordingly, the MME 400 may transmit a forward relocation request message to the AMF 300. The forward relocation request message may include UE ID and SMF+PGW-C ID information supporting the UE's PDN connection (PDU session).

Operation 414: The AMF 300 may transmit a PDU session context request message to the SMF 135, referred to as SMF+PGW-C 135 ID.

Operation 416: The SMF 135 may reply a PDU session context response message to the AMF 300. The PDU session context response message may include the PDU session ID for the UE's PDN connection (PDU session) and the S-NSSAI information associated with the PDU session. The AMF 300 may store the S-NSSAI information associated with a PDU session referred to as the PDU session ID received from the SMF 135.

Operation 418: The AMF 300 may reply a forward relocation response message to the MME 400. The MME 400 may know that the AMF 300 will perform a handover procedure. The MME 400 may determine to continue performing the handover procedure.

Operation 420: In order to continue performing the handover procedure, the MME 400 may transmit a handover command message to the UE 100.

Operation 422: The UE 100 may transmit a handover confirm message to the base station to perform handover to 5GC, and the base station may transmit a handover notify message to the AMF 300. The AMF 300, which has received the handover notify message, may know that the UE 100 has accessed 5G. The AMF 300 may provide allowed slice information to the UE through a registration procedure in operation 424.

Operation 424: The UE 100, which has accessed 5G, may perform a registration procedure. The UE 100 and AMF 300 according to an embodiment of the disclosure may perform the UE registration procedure illustrated in FIG. 3.

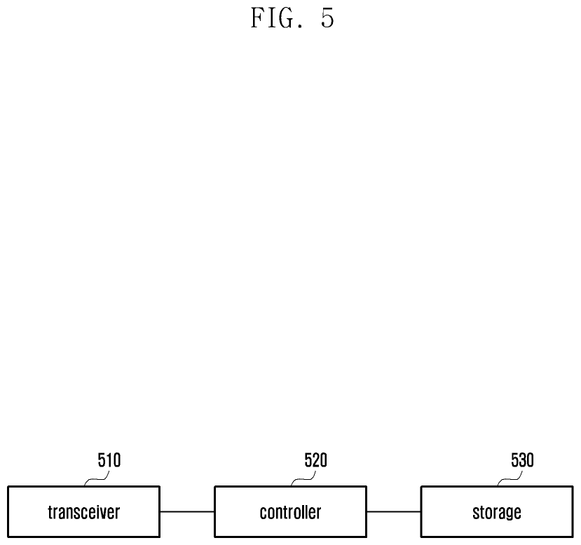

FIG. 5 is a diagram illustrating a structure of a UE according to an embodiment of the disclosure.

With reference to FIG. 5, the UE may include a transceiver 510, a controller 520, and a storage 530. In the disclosure, the controller may be defined as a circuit or application-specific integrated circuit or at least one processor.

The transceiver 510 may transmit/receive a signal to/from a different network entity. The transceiver 510 may receive system information from a base station, for example, and may receive a synchronization signal or a reference signal.

The controller 520 may control an overall operation of the UE according to the embodiments proposed by the disclosure. For example, the controller 520 may control the signal flows between the respective blocks so that the operations according to the above described flowcharts are performed.

The storage 530 may store at least one of information transmitted/received through the transceiver 510 and information generated by the controller 520.

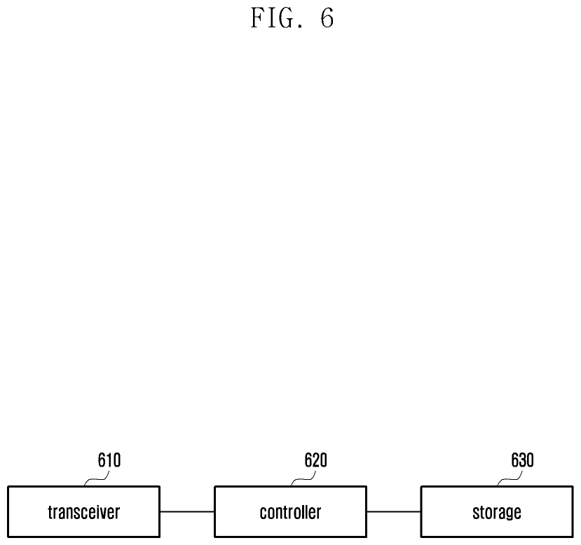

FIG. 6 is a diagram illustrating a structure of a network entity according to an embodiment of the disclosure.

With reference to FIG. 6, the network entity may include a transceiver 610, a controller 620 and a storage 630. In the disclosure, the controller may be defined as a circuit or application-specific integrated circuit or at least one processor.

The transceiver 610 may transmit/receive a signal to/from a different network entity.

The controller 620 may control an overall operation of the UE according to the embodiments proposed by the disclosure. For example, the controller 620 may control the signal flows between the respective blocks so that the operations according to the above described flowcharts are performed.

The storage 630 may store at least one of information transmitted/received through the transceiver 610 and information generated by the controller 620.

1. A method performed by an access and mobility management function (AMF) in a wireless communication system, comprising:
receiving, from a base station, a first message including protocol data unit (PDU) session identifiers;
transmitting, to a network entity, a second message;
receiving, from the network entity, a third message including single-network slice selection assistance information (S-NSSAI) associated with the PDU session identifier;
determining an allowed slice based on the S-NSSAI; and
transmitting, to the base station, a fourth message including the allowed slice.

2. The method of claim 1,
wherein the network entity is a previously selected AMF or mobility management entity (MME),
wherein the second message is a terminal information request message, and
wherein the third message is a terminal information response message.

3. The method of claim 2, wherein the previously selected AMF or MME is identified based on information associated with the terminal ID included in the first message.

4. The method of claim 1,
wherein the network entity is a session management function (SMF),
wherein the second message is a PDU session context request message, and
wherein the third message is a PDU session context response message.

5. The method of claim 1,
wherein a fifth message including at least one of a request slice and a terminal ID is transmitted from the terminal to the base station, and
wherein the fourth message is transmitted from the base station to the terminal.

6. A method performed by a base station in a wireless communication system, comprising:
receiving, from a terminal, a first message including at least one of a request slice and a terminal ID;
selecting an access and mobility management function (AMF) based on at least one of the request slice and the terminal ID;
transmitting, to the AMF, a second message including protocol data unit (PDU) session identifiers;
receiving, from the AMF, a third message including an allowed slice; and
transmitting, to the terminal, the third message,
wherein the allowed slice is determined based on single-network slice selection assistance information (S-NSSAI) associated with the PDU session identifier.

7. The method of claim 6,
wherein a fourth message including the S-NSSAI is transmitted from a network entity to the AMF.

8. The method of claim 6,
wherein the network entity is one of a previously selected AMF, a mobility management entity (MME), and a session management function (SMF).

9. An access and mobility management function (AMF) comprising:
a transceiver capable of transmitting and receiving at least one signal; and
a controller coupled with the transceiver,
wherein the controller is constituted to:
receive, from a base station, a first message including protocol data unit (PDU) session identifiers,
transmit, to a network entity, a second message,
receive, from the network entity, a third message including single-network slice selection assistance information (S-NSSAI) associated with the PDU session identifier,
determine an allowed slice based on the S-NSSAI, and
transmit, to the base station, a fourth message including the allowed slice.

10. The AMF of claim 9,
wherein the network entity is a previously selected AMF or mobility management entity (MME),
wherein the second message is a terminal information request message, and
wherein the third message is a terminal information response message.

11. The AMF of claim 10, wherein the previously selected AMF or MME is identified based on information associated with the terminal ID included in the first message.

12. The AMF of claim 10,
wherein the network entity is a session management function (SMF),
wherein the second message is a PDU session context request message, and
wherein the third message is a PDU session context response message.

13. The AMF of claim 10,
wherein a fifth message including at least one of a request slice and a terminal ID is transmitted from the terminal to the base station, and
wherein the fourth message is transmitted from the base station to the terminal.

14. A base station comprising:
a transceiver capable of transmitting and receiving at least one signal; and
a controller coupled with the transceiver,
wherein the controller is constituted to:
receive, from a terminal, a first message including at least one of a request slice and a terminal ID,
select an access and mobility management function (AMF) based on at least one of the request slice and the terminal ID,
transmit, to the AMF, a second message including protocol data unit (PDU) session identifiers,
receive, from the AMF, a third message including an allowed slice, and
transmit, to the terminal, the third message, and
wherein the allowed slice is determined based on single-network slice selection assistance information (S-NSSAI) associated with the PDU session identifier.

15. The base station of claim 14,
wherein a fourth message including the S-NSSAI is transmitted from a network entity to the AMF, and
wherein the network entity is one of a previously selected AMF, a mobility management entity (MME), and a session management function (SMF).
